(19) United States
(12) Patent Application Publication
(10) Pub. No.: US 2010/0225573 A1
(43) Pub. Date: Sep. 9, 2010

(54) BACKLIGHT DEVICE AND DISPLAY DEVICE

(76) Inventor: Seiji Takeuchi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/680,359

(22) PCT Filed: Jul. 16, 2008
(86) PCT No.: PCT/JP2008/062795

§ 371 Date: Mar. 26, 2010

(30) Foreign Application Priority Data
Oct. 1, 2007 (JP) 2007-257790

(51) Int. Cl. G09G 3/36; G02F 1/13357

(52) U.S. Cl. 345/102; 362/97.1

(57) ABSTRACT

In a backlight device (3) including cold cathode fluorescent tubes (discharge tubes) (20a to 20h), CCFL driving circuits (driving circuits) (T) that light up the respective cold cathode fluorescent tubes (20a to 20h), and a reflective sheet (reflective layer) (19) that reflects light from the cold cathode fluorescent tubes (20a to 20h) in a predetermined direction, a reflective sheet (19) includes a first reflective portion (19a) using a non-conductive member provided in a portion up to a predetermined distance from the CCFL driving circuits (T) in a longitudinal direction of the cold cathode fluorescent tubes (20a to 20h) and a second reflective portion (19b) using a conductive member provided in a portion at a distance exceeding the predetermined distance.

### TECHNICAL FIELD

The present invention relates to a backlight device, and in particular, to a backlight device using a discharge tube such as a cold cathode fluorescent tube, and a display device using the backlight device.

### BACKGROUND ART

Recently, for example, a liquid crystal display device has been used widely in a liquid crystal television, a monitor, a mobile telephone, and the like, as a flat panel display having features such as thinness and lightness in weight, compared with a conventional Braun tube. Such a liquid crystal display device includes an illumination device (backlight device) that emits light and a liquid crystal panel that plays a role as a shutter with respect to light from a light source provided in the backlight device, thereby displaying a desired image.

The above backlight device is classified roughly into a direct type and an edge-light type depending upon the arrangement of the light source with respect to the liquid crystal panel. Further, in the backlight device, generally, light source using discharge tube such as a cold cathode fluorescent tube is provided.

Further, in a conventional backlight device, for example, as described in JP 2002-231034 A, a plurality of the cold cathode fluorescent tubes and driving circuits that light up the respective cold cathode fluorescent tubes are provided, and the backlight device outputs illumination light in a plane shape from a light-emitting surface, which is to be placed so as to be opposed to the liquid crystal panel, to the liquid crystal panel.

Further, the conventional backlight device is configured in such a manner that a metallic reflective plate is provided below the cold cathode fluorescent tubes to reflect the light from the cold cathode fluorescent tubes to the liquid crystal panel side, whereby the use efficiency of the light from the cold cathode fluorescent tubes can be enhanced.

### DISCLOSURE OF INVENTION

### Problem to be Solved by the Invention

However, in the conventional backlight device as described above, a leakage current is generated due to a parasitic capacitance present between the cold cathode fluorescent tube (discharge tube) and the reflective plate (reflective layer). Therefore, the conventional backlight device has a problem that the life of the cold cathode fluorescent tube is decreased due to the leakage current.

Specifically, in the conventional backlight device, due to the leakage current, a lamp current flowing through the inside of the cold cathode fluorescent tube is reduced with increasing distance from the driving circuit, and the tube wall temperature of the cold cathode fluorescent tube is decreased with increasing distance from the driving circuit. Since such non-uniformity of the tube wall temperature distribution occurs, sealed mercury moves to a portion at a lower temperature, that is, a portion on a lower voltage side away from the driving circuit in the cold cathode fluorescent tube.

Consequently, in the conventional backlight device, the amount of mercury on a higher voltage side close to the driving circuit is reduced in the cold cathode fluorescent tube, which makes it impossible for the cold cathode fluorescent tube to perform a lighting-up operation, causing a decrease in life.

Further, it also is conceivable to use a reflective sheet material made of synthetic resin in place of the reflective plate. In the case of using such a reflective sheet material, the heat radiation of the backlight device may be decreased remarkably depending upon the set number of cold cathode fluorescent tubes, the driving voltage thereof, etc., which may cause other problems that the deformation such as warpage occurs in an optical sheet (including a reflective sheet material) provided in the backlight device and a sounding phenomenon is caused by the deformation.

In view of the above problems, an object of the present invention is to provide a backlight device capable of preventing a leakage current from decreasing the life of a discharge tube, and a display device using the backlight device.

### Means for Solving Problem

In order to achieve the above object, a backlight device according to the present invention includes: a discharge tube; a driving circuit that is connected to the discharge tube and lights up the discharge tube; and a reflective layer that reflects light from the discharge tube in a predetermined direction, wherein, in the reflective layer, a non-conductive member is used in a portion up to a predetermined distance from the driving circuit in a longitudinal direction of the discharge tube, and a conductive member is used in a portion at a distance exceeding the predetermined distance.

In the reflective layer in the backlight device configured as described above, the non-conductive member is used in a portion up to a predetermined distance from the driving circuit in the longitudinal direction of the discharge tube, and the conductive member is used in a portion at a distance exceeding the predetermined distance. This can prevent a leakage current from being generated and prevent the life of the discharge tube from being decreased due to the leakage current, unlike the above conventional example.

Further, the backlight device includes: a light-guiding plate that guides the light from the discharge tube in a predetermined direction and a reflective member that is provided so as to surround the discharge tube and reflects the light from the discharge tube to allow the light to be incident upon an inside of the light-guiding plate, wherein, in the reflective member, a non-conductive member is used in a portion up to a predetermined distance from the driving circuit in a longitudinal direction of the discharge tube, and a conductive member is used in a portion at a distance exceeding the predetermined distance.

In this case, in the edge-light type backlight device having the light-guiding plate and the reflective member, the decrease in life of the discharge tube caused by a leakage current can be prevented exactly.

Further, it is preferred that the backlight device includes a housing containing the discharge tube, wherein, in the housing, a non-conductive member is used in a portion up to a predetermined distance from the driving circuit in a longitudinal direction of the discharge tube, and a conductive member is used in a portion at a distance exceeding the predetermined distance.

In this case, the decrease in life of the discharge tube caused by a leakage current can be prevented exactly.

Further, In the backlight device, it is preferred that synthetic resin having a high light reflectance is used for the non-conductive member, and metal having a high light reflectance is used for the conductive member.

In this case, a backlight device excellent in the use efficiency of light from the discharge tube can be configured easily.

Further, in the backlight device, it is preferred that synthetic resin having UV-light resistance and heat resistance is used for the non-conductive member.

In this case, a backlight device can be configured easily in which the degradation with the passage of time, such as the degradation in quality and the deformation caused by UV-light, heat, and the like generated from the discharge tube is unlikely to occur.

Further, a display device of the present invention is characterized by using any of the above backlight devices.

In the display device configured as described above, a backlight device capable of preventing a leakage current from decreasing the life of the discharge tube is used, so that a display device with a long life can be configured easily.

### Effects of the Invention

According to the present invention, a backlight device capable of preventing a leakage current from decreasing the life of a discharge tube, and a display device using the backlight device.

### BRIEF DESCRIPTION OF DRAWINGS

FIG. 1 is a schematic cross-sectional view illustrating a backlight device and a liquid crystal display device according to Embodiment 1 of the present invention.

FIG. 2 is a diagram illustrating configurations of main portions of the backlight device.

FIG. 3 is a diagram illustrating the relationship between a cold cathode fluorescent tube and a reflective sheet shown in FIG. 1.

FIG. 4 is a graph showing a lamp current flowing through the cold cathode fluorescent tube, illustrating the effect of the reflective sheet.

FIG. 5 is a diagram illustrating configurations of main portions of a backlight device according to Embodiment 2 of the present invention.

FIG. 6 is a schematic cross-sectional view illustrating a backlight device and a liquid crystal display device according to Embodiment 3 of the present invention.

FIG. 7 is a perspective view showing a configuration of a reflector shown in FIG. 6.

### DESCRIPTION OF THE INVENTION

Hereinafter, preferred embodiments of a backlight device of the present invention and a display device using the backlight device will be described with reference to the drawings. In the following description, the case where the present invention is applied to a transmission-type liquid crystal display device will be described. Further, the dimensions of constituent members in each figure do not faithfully reflect actual dimensions of the constituent members, dimension ratios of the respective constituent members, and the like.

### Embodiment 1

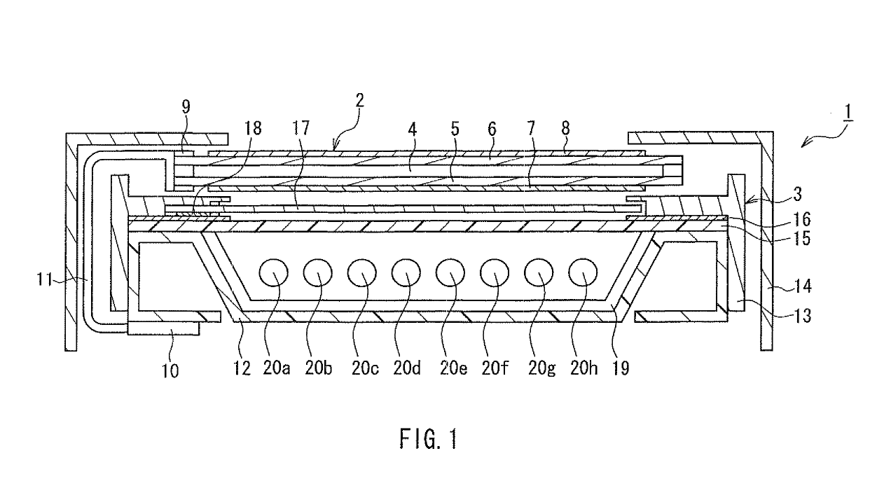

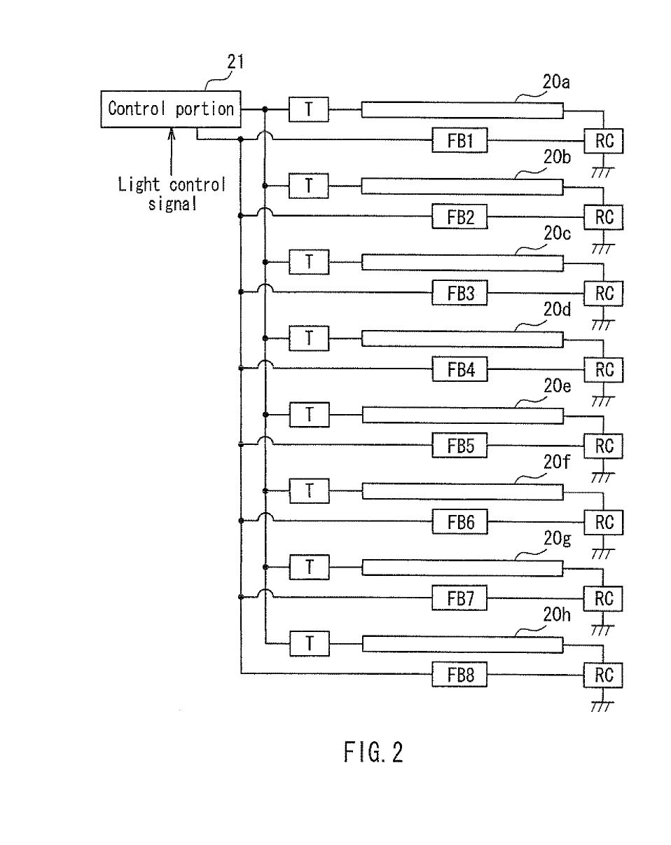

FIG. 1 is a schematic cross-sectional view illustrating a backlight device and a liquid crystal display device according to Embodiment 1 of the present invention. FIG. 2 is a diagram illustrating configurations of main portions of the backlight device. Referring to FIG. 1, in the liquid crystal display device 1 of the present embodiment, there are provided a liquid crystal panel 2 as a display portion that is set with the upper side in the figure being a viewer side (display surface side), and a backlight device 3 of the present invention that is placed on a non-display surface side (lower side in the figure) of the liquid crystal panel 2 and generates illumination light illuminating the liquid crystal panel 2.

The liquid crystal panel 2 includes a liquid crystal layer 4, a pair of transparent substrates 5, 6 sandwiching the liquid crystal layer 4, and polarizing. plates 7, 8 provided on the respective outside surfaces of the transparent substrates 5, 6. Further, the liquid crystal panel 2 is provided with a driver 9 for driving the liquid crystal panel 2 and a driving circuit device 10 connected to the driver 9 via a flexible printed board 11, and the liquid crystal panel 2 is configured so as to chive the liquid crystal layer 4 on a pixel basis. Then, on the liquid crystal panel 2, the polarization state of the illumination light incident through the polarizing plate 7 is modulated by the liquid crystal layer 4, and the amount of light passing through the polarizing plate 8 is controlled, whereby a desired image is displayed.

The backlight device 3 is provided with a housing 12 that is configured so as to have a bottom, with the upper side in the figure (liquid crystal panel 2 side) opened, and contains cold cathode fluorescent tubes (discharge tubes) described later, and a frame 13 set on the liquid crystal panel 2 side of the housing 12. Further, the housing 12 and the frame 13 respectively are formed of synthetic resin and metal, and are sandwiched by a bezel 14 in an L-shape in cross-section with the liquid crystal panel 12 set above the frame 13. Thus, the backlight device 3 is attached to the liquid crystal panel 2 and integrated as the transmission-type liquid crystal display device 1 in which the illumination light from the backlight device 3 is incident upon the liquid crystal panel 2.

Further, the backlight device 3 includes a diffusion plate 15 set so as to cover an opening of the housing 12, an optical sheet 17 set on the liquid crystal panel 2 side above the diffusion plate 15, and a reflective sheet 19 provided on an inner surface of the housing 12. As described later, synthetic resin and metal are used for the reflective sheet 19, and a leakage current can be minimized in the backlight device 3 of the present embodiment.

Further, in the backlight device 3, a plurality of (for example, 8) cold cathode fluorescent tubes (CCFL) 20a, 20b, 20c, 20d, 20e, 20f, 20g, 20h as linear light sources are arranged in parallel with each other above the reflective sheet 19. Further, the respective cold cathode fluorescent tubes 20a to 20h are arranged at an equal interval with a predetermined interval (pitch) dimension in a direction (horizontal direction in FIG. 1) perpendicular to the longitudinal direction of the cold cathode fluorescent tubes 20a to 20h, and light from the respective cold cathode fluorescent tubes 20a to 20h is output as the above illumination light from the light-emitting surface of the backlight device 3 placed so as to be opposed to the liquid crystal panel 2.

The diffusion plate 15 is formed of synthetic resin or a glass material in a rectangular shape with a thickness of, for example, about 2 mm, diffuses light (containing light reflected from the reflective sheet 19) from the cold cathode fluorescent tubes 20a to 20h and outputs the light to the optical sheet 17 side. Further, four sides of the diffusion plate 15 are placed on a frame-shaped surface of the housing 12 provided on the upper side thereof, and the diffusion plate 15 is incorporated inside the backlight device 3 while being sandwiched between the frame-shaped surface of the housing 12 and the inner surface of the frame 13 with a pressure member 16 capable of being deformed elastically interposed therebetween. Further, the diffusion plate 15 is supported substantially at the center portion thereof by a transparent support member (not shown) set on the reflective sheet 19, whereby the diffusion plate 15 is prevented from being bent toward the inside of the housing 12.

Further, the diffusion plate 15 is held so as to move between the housing 12 and the pressure member 16. Even when the diffusion plate 15 is expanded/contracted (plastically deformed) due to the influence of the heat generated in the cold cathode fluorescent tubes 20a to 20h, the heat caused by the increase in temperature inside the housing 12, and the like, the plastic deformation is absorbed by the elastic deformation of the pressure member 16, whereby the decrease in diffusion of the light from the cold cathode fluorescent tubes 20a to 20h is minimized. Further, it is preferred to use the diffusion plate 15 formed of glass, which is more resistant to heat compared with synthetic resin, since the warpage, yellowing, thermal deformation, and the like caused by the above influence of heat are unlikely to occur.

The optical sheet 17 includes a diffusion sheet composed of a synthetic resin film with a thickness of, for example, about 0.5 mm, and is configured so as to diffuse the illumination light to the liquid crystal panel 2 appropriately to enhance the display quality on the display surface of the liquid crystal panel 2. Further, on the optical sheet 17, known optical sheet materials, which enhance the display quality on the display surface of the liquid crystal panel 2, such as a prism sheet and a polarizing sheet are laminated appropriately, if required. Then, the optical sheet 17 is configured so as to convert the light output from the diffusion plate 15 into plane-shaped light having a predetermined brightness (for example, 10000 cd/m²) or more and having an almost uniform brightness and allows the converted light to be incident upon the liquid crystal panel 2 side as illumination light. Besides the above description, for example, an optical member such as a diffusion sheet for adjusting the viewing angle of the liquid crystal panel 2 may be laminated appropriately above (display surface side of) the liquid crystal panel 2.

Further, the optical sheet 17 is provided with a protrusion protruding to the left side in FIG. 1, at the center on the left end side in FIG. 1, which is to be the upper side, for example, during actual use of the liquid crystal display device 1. Then, in the optical sheet 17, only the protrusion is sandwiched between the inner surface of the frame 13 and the pressure member 16 with an elastic material 18 interposed therebetween, and the optical sheet 17 is incorporated inside the backlight device 3 so as to be capable of expanding/contracting.

Thus, the optical sheet 17 is configured in such a manner that, even when the expansion/contraction (plastic) deformation occurs due to the above influence of heat such as the heat generated in the cold cathode fluorescent tubes 20a to 20h, the optical sheet 17 is capable of expanding/contracting freely with respect to the protrusion, whereby wrinkles, warpage, and the like are minimized in the optical sheet 17. Consequently, in the liquid crystal display device 1, the degradation in display quality such as non-uniform brightness can be minimized on the display surface of the liquid crystal panel 2 due to the warpage and the like of the optical sheet 17.

In each of the cold cathode fluorescent tubes 20a to 20h, a straight-tube fluorescent lamp type is used, and electrodes (not shown) provided at both ends thereof are supported outside of the housing 12. Further, in each of the cold cathode fluorescent tubes 20a to 20h, thinned tubes excellent in an emission efficiency with a diameter of about 3.0 to 10 mm is used, and each of the cold cathode fluorescent tubes 20a to 20h is held inside the housing 12 while the distance between the diffusion plate 15 and the reflective sheet 19 is held at a predetermined distance by a light source holding tool (not shown).

Further, the cold cathode fluorescent tubes 20a to 20h are arranged so that the longitudinal direction thereof is parallel to a direction perpendicular to the action direction of a gravity Thus, in the cold cathode fluorescent tubes 20a to 20h, mercury (vapor) sealed inside the cold cathode fluorescent tubes 20a to 20h is prevented from being collected on one end side of the longitudinal direction due to the action of a gravity whereby the life of a lamp is enhanced largely.

Further, referring to FIG. 2, in the backlight device 3, a control portion 21 that drives each of the plurality of cold cathode fluorescent tubes 20a to 20h and CCFL driving circuits T as driving circuits that are provided for the respective cold cathode fluorescent tubes 20a to 20h and light up the corresponding cold cathode fluorescent tubes 20a to 20h based on a driving signal from the control portion 21. Further, the backlight device 3 includes lamp current detection circuits RC that are provided for the respective cold cathode fluorescent tubes 20a to 20h and detect the values of lamp currents flowing through the corresponding cold cathode fluorescent tubes 20a to 201h, and in the backlight device 3, the lamp current value detected by each lamp current detection circuit RC is output to the control portion 21 via feedback circuits FB1, FB2, FB3, FB4, FB5, FB6, FB7, and FB8 set in accordance with the respective cold cathode fluorescent tubes 20a to 20h.

Each of the cold cathode fluorescent tubes 20a to 20h starts being lit up at a starting voltage of, for example, 600 V, and is lit up at 400 Vrms during lighting.

Further, the control portion 21 receives a light control signal of changing the brightness of a light-emitting surface of the backlight device 3 from outside, and in the liquid crystal display device 1, a user can change the brightness (lightness) appropriately on the display surface of the liquid crystal panel 2. That is, in the liquid crystal display device 1, when the user provides an operation instruction with respect to a brightness adjusting portion (not shown) for adjusting the brightness on the display surface provided on the liquid crystal display device 1 side, for example, the light control signal in accordance with the operation instruction is input to the control portion 21 from the brightness adjusting portion. Then, the control portion 21 determines a target value of a supply current value to each of the cold cathode fluorescent tubes 20a to 20h in accordance with the input light control signal. After that, the control portion 21 generates and outputs a driving signal to each CCFL driving circuit T based on the determined target value, whereby the value of a lamp current flowing through the corresponding cold cathode fluorescent tubes 20a to 20h changes.

Consequently, the amount of output light from each of the cold cathode fluorescent tubes 20a to 20h changes in accordance with the light control signal, and the brightness on the light-emitting surface of the backlight device 3 and the brightness on the display surface of the liquid crystal panel 2 are changed appropriately in accordance with the user's operation instruction.

Further, the lamp current value supplied actually to each of the cold cathode fluorescent tubes 20a to 20h is fed back as a detected current value to the control portion 21 via the corresponding lamp current detection circuits RC and the feedback circuits FB1 to FB8. Then, in the control portion 21, the feedback control is performed using the detected current value and the target value of the supply current value determined based on the light control signal, whereby a display is maintained at a user's desired brightness.

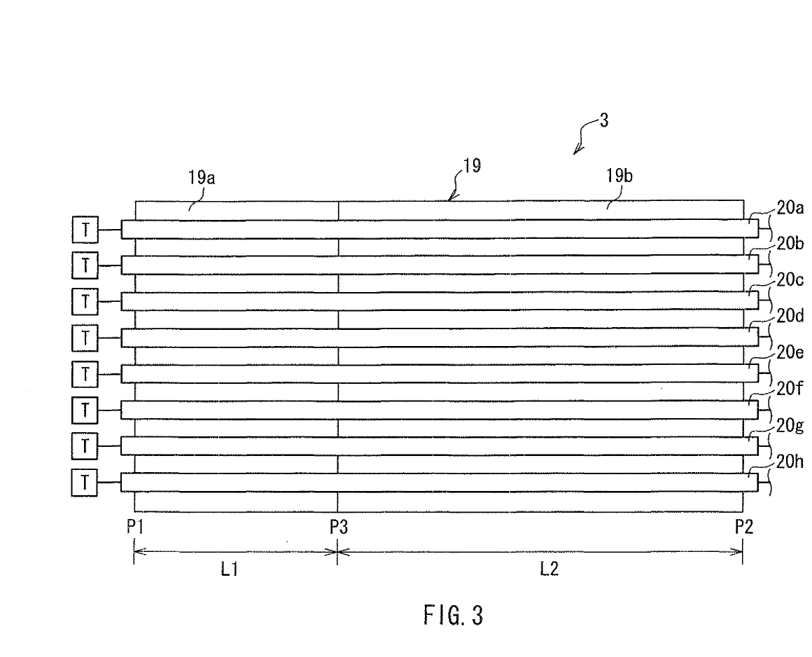

Hereinafter, the reflective sheet 19 will be described specifically with reference to FIG. 3.

FIG. 3 is a diagram illustrating the relationship between the cold cathode fluorescent tube and the reflective sheet shown in FIG. 1.

In FIG. 3, the reflective sheet 19 constitutes a reflective layer that reflects light from the cold cathode fluorescent tubes 20a to 20h in a predetermined direction (direction on the liquid crystal panel 2 side), and efficiently reflects the light emitted from the cold cathode fluorescent tubes 20a to 20h to the diffusion plate 15 side to enhance the use efficiency of the light and the brightness in the diffusion plate 15.

Further, in the reflective sheet 19, a first reflective portion 19a using a non-conductive member is provided in a portion up to a predetermined distance from the CCFL driving circuits Tin the longitudinal direction (horizontal direction in FIG. 3) of the cold cathode fluorescent tubes 20a to 20h, and a second reflective portion 19b using a conductive member is provided in a portion at a distance exceeding the predetermined distance.

Specifically, in the reflective sheet 19, the first reflective portion 19a and the second reflective portion 19b are provided integrally in this order from the CCFL driving circuits T side. Further, in the reflective sheet 19, as the predetermined distance, for example, ⅓ of the dimension in the longitudinal direction between a left end P1 and a right end P2, for example, is adopted. More specifically, a dimension L1 of the first reflective portion 19a in the longitudinal direction is set to be ½ of a dimension L2 of the second reflective portion 19b in the longitudinal direction.

Further, in the non-conductive member, for example, white synthetic resin having a high light reflectance, such as polycarbonate or PET (polyethylene terephthalate) resin is used.

On the other hand, for example, metal having a high reflectance such as aluminum and silver (also including metal subjected to mirror finish) is used as a conductive member. Thus, materials having a high light reflectance are selected for the first and second reflective portions 19a, 19b, whereby the light use efficiency of the cold cathode fluorescent tubes 20a to 20h is enhanced.

Further, the above synthetic resin having UV-light resistance and heat resistance is used for the first reflective portion 19a, whereby the degradation in quality, deformation, and the like caused by UV-light and heat from the cold cathode fluorescent tubes 20a to 20h are minimized. Further, the presence of the second reflective portion 19b prevents the decrease in radiation of heat generated in the cold cathode fluorescent tubes 20a to 20h, and minimizes the deformation and the like of the optical sheet 17, etc.

Besides the above description, paint in white color or the like having a high light reflectance may be applied to the surfaces of the first and second reflective portions 19a and 19b on the diffusion plate 15 side.

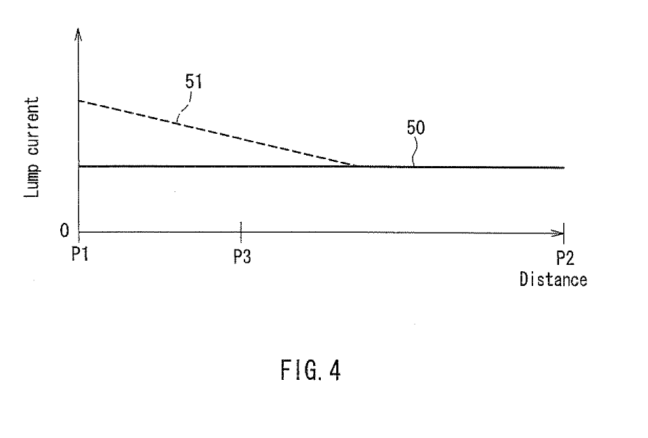

Next, the effects of the reflective sheet 19 will be described specifically with reference to FIG. 4.

FIG. 4 is a graph illustrating a lamp current flowing through the cold cathode fluorescent tube, illustrating the effect of the reflective sheet.

In the backlight device 3 of the present embodiment, since the first reflective portion 19a is used from the left end P1 on the CCFL driving circuits T side to the point P2, a parasitic capacitance is not present between the first reflective portion 19a and each of the cold cathode fluorescent tubes 20a to 20h, and a leakage current is not generated. Thus, in each of the cold cathode fluorescent tubes 20a to 20h, a lamp current (tube current) flowing through the inside of the cold cathode fluorescent tubes 20a to 20h takes a substantially uniform value between the left end P1 and the right end P2 as indicated by a solid line 50 in FIG. 4, unlike the case where a leakage current is generated as indicated by a dotted line 51 in FIG. 4. Thus, in the backlight device 3 of the present embodiment, a tube wall temperature distribution also becomes substantially uniform in each of the cold cathode fluorescent tubes 20a to 20h.

Consequently, in each of the cold cathode fluorescent tubes 20a to 20h, unlike the above conventional example, mercury sealed inside is prevented from moving from the left end P1 side (high-voltage side) to the right-end P2 side (low-voltage side) exactly. Thus, mercury is allowed to be present almost uniformly, which can prevent a leakage current to cause non-lighting. Further, as described above, since the generation of a leakage current is prevented, in each of the cold cathode fluorescent tubes 20a to 20h, the light emission amount in the longitudinal direction can be rendered substantially uniform, and the generation of a brightness gradient (non-uniform brightness) caused by the leakage current also can be prevented.

In the backlight device 3 of the present embodiment as configured above, the first and second reflective portions 19a and 19b respectively using a non-conductive material and a conductive material are provided on the reflective sheet (reflective layer) 19. Further, in the reflective sheet 19, the first reflective portion 19a is used in a portion up to a predetermined distance in the longitudinal direction of the cold cathode fluorescent tubes (discharge tubes) 20a to 20h, and the second reflective portion 19b is used in a portion at a distance exceeding the predetermined distance. Thus, unlike the conventional example, in the backlight device 3 of the present embodiment, a leakage current can be prevented, and the life of each of the cold cathode fluorescent tubes 20a to 20h can be prevented from decreasing due to the leakage current, as indicated by the solid line 50 in FIG. 4.

Further, the liquid crystal display device 1 of the present embodiment uses the backlight device 3 capable of preventing the life of each of the cold cathode fluorescent tubes 20a to 20h from decreasing due to the leakage current, so that the liquid crystal display device 1 with a long life can be configured easily.

In the above description, the case where ⅓ of the dimension in the longitudinal direction is used as a predetermined distance has been described. However, as the reflective sheet 19 of the present embodiment, any sheet can be used as long as it is capable of preventing the generation of a leakage current in the first reflective portion 19a on the CCFL driving circuits T side. The predetermined distance can be changed appropriately in accordance with the material and thickness of the non-conductive member constituting the first reflective portion 19a, the driving voltage of the cold cathode fluorescent tubes (discharge tubes) 20a to 20h, and the like.

### Embodiment 2

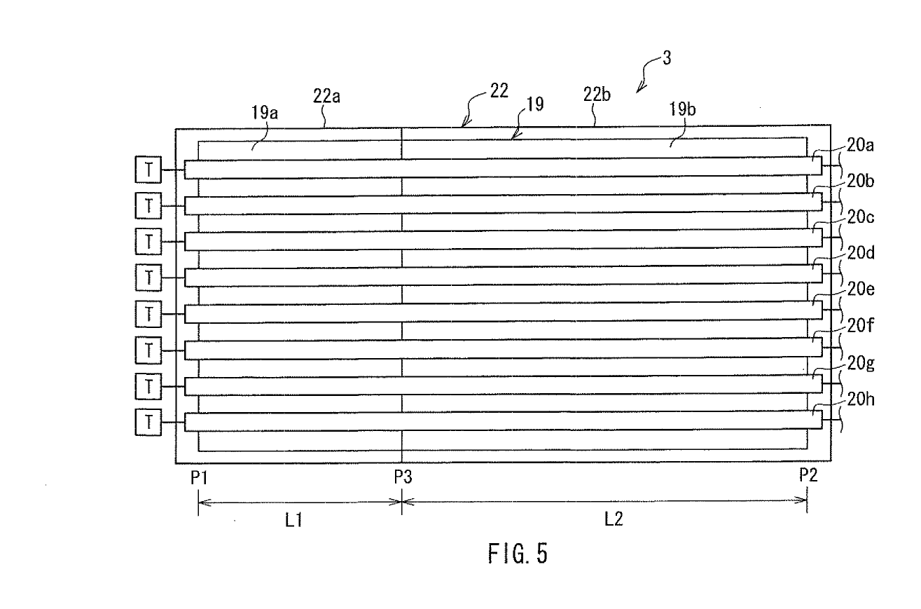

FIG. 5 illustrates configurations of main portions of a backlight device according to Embodiment 2 of the present invention. In the figure, the present embodiment is different from Embodiment 1 mainly in that a housing having a first housing portion made of synthetic resin and a second housing portion made of metal is used in place of the housing made of synthetic resin. The same elements as those in Embodiment 1 are denoted with the same reference numerals as those therein, and the repeated descriptions thereof will be omitted

More specifically, as shown in FIG. 5, in the backlight device 3 of the present embodiment, a housing 22 has first and second housing portions 22a and 22b respectively using a non-conductive member and a conductive member in the same way as in the reflective sheet 19. The first housing portion 22a is provided in a portion up to a predetermined distance from the CCFL driving circuits Tin the longitudinal direction of the cold cathode fluorescent tubes 20a to 20h (for example, a portion from the left end to the point P2). On the other hand, the second housing portion 22b is provided in a portion at a distance exceeding the predetermined distance (for example, a portion from the point P2 to the right end).

Due to the above configuration, the backlight device 3 of the present embodiment exhibits the functional effects similar to those in Embodiment 1. Further, in the backlight device 3 of the present embodiment, the first housing portion 22a using a non-conductive member is provided in a portion up to a predetermined distance from the CCFL driving circuits Tin the longitudinal direction of the cold cathode fluorescent tubes 20a to 20h, so that the decrease in life of the cold cathode fluorescent tubes 20a to 20h caused by a leakage current can be prevented more exactly.

### Embodiment 3

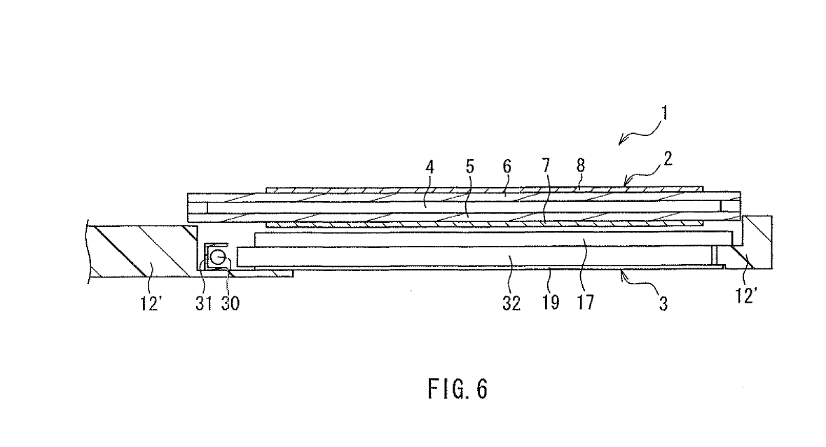

FIG. 6 is a schematic cross-sectional view illustrating a backlight device and a liquid crystal display device according to Embodiment 3 of the present invention. In the figure, the present embodiment is different from Embodiment 1 mainly in that the present embodiment is configured as an edge-light type having a light-guiding plate that guides light from a cold cathode fluorescent tube in a predetermined direction and a reflector that is provided so as to surround the cold cathode fluorescent tube and allows light from the cold cathode fluorescent tube to be incident upon the light-guiding plate, and synthetic resin and metal are used in the reflector. The same elements as those in Embodiment 1 are denoted with the same reference numerals as those therein, and the repeated descriptions thereof will be omitted.

More specifically, as illustrated in FIG. 6, in the backlight device 3 of the present embodiment, one cold cathode fluorescent tube 30 is provided in a direction perpendicular to the drawing surface of FIG. 6. The backlight device 3 includes a reflector 31 in a substantially U-shape in cross-section provided so as to surround the cold cathode fluorescent tube 30 and a light-guiding plate 32 that receives light from the cold cathode fluorescent tube 30 and guides the light in a predetermined direction (horizontal direction in FIG. 6), thereby constituting an edge-light type backlight device.

Further, in the backlight device 3, the reflective sheet 19 is provided below the light-guiding plate 32 so as to function also as a bottom surface of a housing 12′ made of synthetic resin, and attached to the housing 12′.

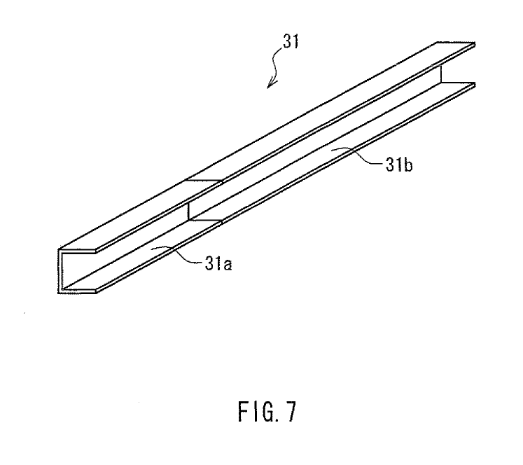

Herein, the reflector 31 will be described specifically with reference to FIG. 7.

FIG. 7 is a perspective view showing a configuration of the reflector shown in FIG. 6.

As shown in FIG. 7, the reflector 31 includes a space having a rectangular shape in cross-section, in which the cold cathode fluorescent tube 30 can be placed, and the reflector 31 constitutes a reflective member that reflects light from the placed cold cathode fluorescent tube 30 and allows the light to be incident upon the light-guiding plate 32. Further, the reflector 31 includes first and second reflector portions 31a and 32b respectively using a non-conductive member and a conductive member in the same way as in the reflective sheet 19.

The first reflector portion 31a is provided in a portion up to a predetermined distance from an end at which a high-voltage electrode of the cold cathode fluorescent tube 30 is provided (that is, an electrode end to which the CCFL driving circuit T is connected) in the longitudinal direction of the cold cathode fluorescent tube 30. On the other hand, the second reflector portion 31b is provided in a portion at a distance exceeding the predetermined distance.

With the above configuration, the backlight device 3 of the present embodiment exhibits functional effects similar to those of Embodiment 1. Further, in the backlight device 3 of the present embodiment, the first reflector portion 31a using a non-conductive member is provided in a portion up to a predetermined distance from an end at which a high-voltage electrode of the cold cathode fluorescent tube 30 is provided in the longitudinal direction of the cold cathode fluorescent tube 30; therefore, the decrease in life of the cold cathode fluorescent tube (discharge tube) 30 caused by a leakage current can be prevented exactly, in the edge-light type backlight device 3 having the light-guiding plate 32 and the reflector (reflective member) 31.

The above embodiments are not limiting but are shown merely for illustrative purposes. The technical range of the present invention is defined by the claims, and all the alterations within the range equivalent to the configuration recited in the claims also are included in the technical range of the present invention.

For example, in the above description, although the case where the present invention is applied to a transmission-type liquid crystal display device has been described, the backlight device of the present invention is not limited thereto, and the present invention also can be applied to various display devices including a non-light-emitting display portion that displays information such as images and characters, using the light from the discharge tube. Specifically, the backlight device of the present invention can be used preferably for a semi-transmission type liquid crystal display device or a projection-type display device using a liquid crystal panel in a light valve.

Further, besides the above description, the present invention can be used preferably as a backlight device for a film viewer that irradiates an X-ray photograph with light, a light box that irradiates a negative or the like with light to make it easy to recognize the negative visually, or a light-emitting device for lighting up a signboard or advertisement set on a wall surface in a station premise.

Further, in the above description, although the case using a cold cathode fluorescent tube has been described, the discharge tube of the present invention is not limited thereto, and other discharge fluorescent tubes such as a hot cathode fluorescent tube and a xenon fluorescent tube, or non-straight discharge fluorescent tubes such as a U-tube and a pseudo-U-tube also can be used.

More specifically, according to the present invention, in a backlight device having a discharge tube, a driving circuit that lights up the discharge tube, and a reflective layer that reflects light from the discharge tube in a predetermined direction, a non-conductive member may be used in a portion up to a distance from a driving circuit in the longitudinal direction of the discharge tube in a reflective layer, and a conductive member is used in a portion at a distance exceeding the predetermined distance. The kind, set number, driving system of a discharge tube, the configuration of a driving circuit, etc. are not limited to the above.

Further, in the case of using a discharge fluorescent tube with less mercury, such as the xenon fluorescent tube, a long-life backlight device having discharge tubes arranged in parallel with the action direction of a gravity can be configured.

Further, in the above description, the configuration has bee described in which a CCFL driving circuit (driving circuit) is set at one end in the longitudinal direction of the cold cathode fluorescent tube (discharge tube), and the cold cathode fluorescent tube is driven from one side in the longitudinal direction. However, the present invention is not limited thereto, and driving circuits may be set respectively on both sides of the discharge tube, and the discharge tube may be driven from both sides.

In the case of the above configuration, the center portion of the reflective layer in the longitudinal direction of the discharge tube is formed of a conductive member, and both ends, which are provided to be respectively close to the driving circuits so as to sandwich the center portion, are formed of a non-conductive member.

Further, in the above description, the case has been described in which synthetic resin such as polycarbonate resin or PET resin is used as a non-conductive member, and metal such as aluminum and silver is used as a conductive member; however, the non-conductive member and the conductive member of the present invention are not limited thereto.

It is preferred that synthetic resin and metal having a high light reflectance are used respectively for a non-conductive member and a conductive member as in the above embodiment, since a backlight device excellent in use efficiency of light from the discharge tube can be configured easily.

Further, as in the above embodiment, it is preferred that synthetic resin having UV-light resistance and heat resistance is used for a non-conductive member, since a backlight device can be configured easily in which the degradation with the passage of time, such as the degradation in quality and the deformation caused by UV-light, heat, and the like generated from the discharge tube is unlikely to occur.

Further, in the above description, the configuration has been described in which synthetic resin (non-conductive member) is used in an entire or partial housing. The present invention is not limited thereto, and a conductive member such as metal also can be used depending upon the material and thickness of a reflective layer provided on the discharge tube side. More specifically, in the case where the generation of a leakage current is prevented by the reflective layer, a housing also can be configured using a conductive member.

### INDUSTRIAL APPLICABILITY

The present invention is useful with respect to a backlight device capable of preventing the decrease in life of a discharge tube caused by a leakage current, and a display device using the backlight device.

1. A backlight device, comprising:
a discharge tube;
a driving circuit that is connected to the discharge tube and lights up the discharge tube; and
a reflective layer that reflects light from the discharge tube in a predetermined direction,
wherein, in the reflective layer, a non-conductive member is used in a portion up to a predetermined distance from the driving circuit in a longitudinal direction of the discharge tube, and a conductive member is used in a portion at a distance exceeding the predetermined distance.

2. The backlight device according to claim 1, comprising:
a light-guiding plate that guides the light from the discharge tube in a predetermined direction and a reflective member that is provided so as to surround the discharge tube and reflects the light from the discharge tube to allow the light to be incident upon an inside of the light-guiding plate,
wherein, in the reflective member, a non-conductive member is used in a portion up to a predetermined distance from the driving circuit in a longitudinal direction of the discharge tube, and a conductive member is used in a portion at a distance exceeding the predetermined distance.

3. The backlight device according to claim 1, comprising a housing containing the discharge tube,
wherein, in the housing, a non-conductive member is used in a portion up to a predetermined distance from the driving circuit in a longitudinal direction of the discharge tube, and a conductive member is used in a portion at a distance exceeding the predetermined distance.

4. The backlight device according to claim 1, wherein synthetic resin having a high light reflectance is used for the non-conductive member, and metal having a high light reflectance is used for the conductive member.

5. The backlight device according to claim 4, wherein synthetic resin having UV-light resistance and heat resistance is used for the non-conductive member.

6. A display device using the backlight device according to claim 1.
